(19) United States
(12) Patent Application Publication
(10) Pub. No.: US 2009/0252852 A1
(43) Pub. Date: Oct. 8, 2009

(54) Aqueous Drink Product

(76) Inventors: Michel Mellema, Vlaardingen (NL); Farley Ferdinand Tio, Vlaardingen (NL)

Correspondence Address: UNILEVER PATENT GROUP, 800 SYLVAN AVENUE, AG West S. Wing, ENGLEWOOD CLIFFS, NJ, 07632-3100, US

(21) Appl. No.: 12/085,082

(22) PCT Filed: Oct. 25, 2006
(86) PCT No.: PCT/EP2006/010322

§ 371 Date: May 15, 2008

(30) Foreign Application Priority Data
Nov. 24, 2005 (EP) 05077686.3

(51) Int. Cl. A23L 2/66; A23L 2/38

(52) U.S. Cl. 426/598

(57) ABSTRACT

The invention relates to an aqueous drink product having a pH in the range of from 5.3 to 8.0 and comprising 1-6 wt. % soy protein, from 0-10 wt. % fat, from 0.25-1.75 wt. % saturated monoglyceride emulsifier and from 0.01-2.5 wt. % of water-insoluble edible inorganic salts. The products have a an improved level of lack of sedimentation and/or precipitation.

### FIELD OF THE INVENTION

The invention relates to aqueous drink products, especially soy-based drinks.

### BACKGROUND ART

There is an increasing demand for food products which are perceived by the consumer as healthy, or, as giving health benefits. Furthermore, such products should have acceptable taste, acceptable stability and ideally be available in convenient forms such as drinks. In particular, and at least in part due to increasing concerns regarding the safety of protein from animal sources, there is a need for such products which contain protein(s) from sources other than bovine sources (and to a somewhat lesser extent from other non-animal sources). Proteins from non-animal sources are becoming increasingly renowned for their health or physiological benefits, for example cardio-vascular benefits. An example of such a protein is soy protein.

It is known in the art that products based upon soy protein, often have a tendency to suffer from physical instability at certain pHs. In particular the proteins may exhibit a degree of sedimentation and/or precipitation of the protein at acidic pH.

An alternative problem with sedimentation occurs at higher pH, around neutral pH, especially with soy based drinks fortified with calcium. It is desirable to fortify soy-based drinks with calcium to give a nutritional benefit to the consumer. It is also important to do this as soy-based drinks tend to have little or no calcium present inherently from the soy protein. As soy protein is used as an alternative to dairy protein drinks, it is desirable for the consumer to have a certain level of calcium fortification present so that the consumer suffers little or no nutritional loss. The problem faced in soy protein based drinks with calcium fortification is that the calcium salts present in the composition tend to form an unwanted sediment at the bottom of the product.

Sedimentation is accompanied by the growth of a layer of ingredients at the bottom of the product. An example of this is the heaviest ingredients in a product sinking to the bottom of the packaging. This constitutes a large problem in the field of drinks products for consumers as this leaves an off-putting residue at the bottom of the drink product unless vigorous shaking is done before use.

U.S. Pat. No. 4,389,425 discloses soy-based milk and a method for making it. Soaked soy beans are blanched and ground in the presence of an acidified water solution having a pH of 1.4 to prevent coagulation of the extracted soy beans and produce a stable milk. Citric acid, hydrochloric acid or phosphoric acid may be used. The pH of the product is raised and the final pH is about 7.

WO 2005/053414 A1 discloses a sterilised aqueous suspension comprising protein and fat or a fat replacer and from 0.1 wt. % to 1 wt. % emulsifier for reducing age gelation.

A problem which can be encountered in food products comprising non-animal protein, and which are not substantially solid, for example aqueous soy-based drinks, is sedimentation and/or precipitation of the calcium salt used for fortification. This is especially a problem at a pH around pH neutral, but specifically between pH 5.3 and 8.0. The result is that undesirable sedimentation occurs in the drink product which is off-putting for the consumer and removes calcium from possible consumption by the consumer.

It is therefore difficult to find an acceptable balance between on the one hand providing a drink product which provides a good level of calcium to the consumer and on the other hand maintaining the physical stability of the product. If a product is formulated with calcium which provides essential minerals for the consumer, the calcium has a tendency to sediment and/or to precipitate. Conversely, if the product is formulated so as to be physically stable without sedimentation, then the level of obtainable calcium fortification will not generally be sufficient for the consumer.

Therefore there is a need for an aqueous drink product comprising soy protein with calcium fortification and which displays reduced sedimentation.

The present invention seeks to address the above problem.

### SUMMARY OF THE INVENTION

We have surprisingly found that by formulating an aqueous drink product comprising soy protein, fat, a water-insoluble inorganic salt and a saturated monoglyceride emulsifier the above problem can be addressed.

Therefore the present invention provides an aqueous drink product comprising a) from 1.0-5.0 wt. % soy protein; b) from 0-10 wt. % fat; c) from 0.25-1.75 wt. % saturated monoglyceride emulsifier; and d) from 0.01-2.5 wt. % of water-insoluble edible inorganic salts.

The products of the invention are desirable for being soy-based which is becoming important for health conscious consumers as well as those intolerant to milk. The products are formulated to have a pH in the range of pH 5.3 to 8.0. Furthermore, the products according to the invention have the advantage of reduced sedimentation or precipitation, this property being evidenced by a reduction in the amount of solids separated out from the aqueous drink product, upon storage for 1 week at 5° C.

### DETAILED DESCRIPTION

All wt. % values stated herein are based on the percentage by weight of the ingredient present in the final product unless otherwise stated.

In the context of the present invention it is to be understood that the terms “soy protein” and “soya protein” are used interchangeably in the art to describe protein(s) derived from soya (soy) beans.

The soy protein may be used in any suitable form, for example, combined with an amount of one or more oils to help the preparation of the food product, or as a powder or solution. It may be used as an extraction from the protein source, protein concentrate or protein isolate. Protein isolates, especially soy protein isolates, are especially preferred.

The amount of soy protein present is from 1.0-6.0 wt. %, preferably from 1.5-5.0 wt. %, more preferably from 2.0-4.0 wt. %.

The term “fat” is used herein to describe the range of edible triglyceride fats and oils which can be incorporated into the product. Fat and oil may sometimes be used interchangeably herein, for instance fat phase and oil phase and fat content or oil content may be used to indicate the same. Preferably the fats used are vegetable fats. In those embodiments where the fat is a vegetable fat, the fat is preferably selected from the group comprising sunflower oil, rapeseed oil, soy bean oil, olive oil, linseed oil or a combination thereof. The most preferred fats have a polyunsaturated fatty acid (PUFA) content of at least 30 wt. % PUFA on total triglyceride composition.

The amount of fat present in products according to the present invention is from 0-10 wt. %, more preferred is from 0-8 wt. % fat, even more preferred is from 0-7.5 wt. % fat.

Compositions of the invention also contain one or more emulsifiers, for the purposes of the invention the first emulsifier is a saturated monoglyceride emulsifier. Even more preferred is a saturated C₁₆ or C₁₈ monoglyceride emulsifier or a mixture thereof. Examples of such emulsifiers are Hymono™ 8903 and Dimodan™ hp. In the context of the invention proteins are not included in the term emulsifier.

The amount of saturated monoglyceride emulsifier is from 0.25-1.75 wt. %, preferably from 0.75-1.75 wt. %, more preferably from 1.0-1.5 wt. %.

Additionally, compositions of the invention may optionally comprise one or more additional emulsifiers other than the saturated monoglyceride emulsifier described above. The second and possibly subsequent emulsifiers can be for example selected from the group comprising lecithins, diglycerides, diacetyl tartaric acid esters of mono- and diglycerides, sucrose esters of fatty acids, sodium steoroyl lactylate (SSL), citric acid esters of mono- and diglycerides, or a combination thereof. The additional emulsifiers are present in an amount of from 0.1-5 wt. %, preferably 0.1-4 wt. %, more preferably 0.1-3 wt. %.

Compositions of the invention also comprise water-insoluble edible inorganic salts. Although these can include, for example magnesium or zinc salts, wherein the preferred minerals are the carbonate and the phosphate salts; it is preferred that the water-insoluble edible inorganic salts are calcium salts. More preferred the said salt is calcium carbonate, calcium phosphate, (for example, calcium triphosphate (TCP)), or a mixture thereof.

The water-insoluble edible inorganic salts are present in compositions according to the invention in a lower limit of an amount of 0.01 wt. % or above, preferably 0.05 wt. % or above, more preferably the amount is 0.1 wt. % or above. The upper limit for incorporation of these salts is 2.5 wt. %, preferably 2 wt. % or lower, more preferably 0.5 wt. % or lower. The amount of water-insoluble edible inorganic salts in the composition falls within the range 0.01-2.5 wt. %, preferably 0.02-2.0 wt. %, more preferably, 0.02-1.0 wt. %, even more preferably 0.05-0.25 wt. % and most preferably from 0.1-0.2 wt. %.

An advantage of compositions according to the present invention is the large level of calcium fortification present. It also provides a healthy, calcium enriched drink product. The level of calcium present in the drink product can be from 100 mg/100 ml to 400 mg/100 ml, preferably 120 mg/100 ml to 300 mg/100 ml, more preferably 140 mg/100 ml to 280 mg/100 ml, based on weight of calcium salt per 100 ml of drink product.

The term “water-insoluble edible inorganic salts” refers to the addition of various (edible) minerals/salts of multivalent metal ions that are not water soluble into the drink product. For the context of the present invention, ‘inorganic salt’ refers to the composition of the ingredient before addition to the formulation. Water-insoluble can be classified as being not water soluble or only very sparingly soluble, preferably less than 100 mg/100 ml in water at 20° C. at pH 7. These salts include inorganic salts of calcium, magnesium or zinc metals. Preferably the inorganic salt is a calcium salt.

The drink products of the invention have a pH range of from pH 5.3 to 8.0, preferably from pH 5.5 to 8.0, more preferably from pH 5.5 to 7.5. The drink products can also be formulated at neutral pH.

Alternatively, according to another embodiment of the invention, the drink products can be formulated at acidic pH to impart an acidic taste upon the consumer. The acidic pH, hence taste can be made using edible organic acids, fruit, fruit juice, fruit extract, or a combination of the above.

According to one embodiment of the invention it is preferred that the food product comprises fruit or fruit juice. The addition of the fruit or fruit juice has flavour benefits and is also frequently desired by the consumer because of its perceived health benefits. Any desired fruit or fruit juice can be added. It is especially preferred that acidic fruit or fruit juices are used. Examples of suitable fruits are orange, kiwi, lemon, pineapple, clementines, mandarin, lime, apple, pear etc are used. Also preferred are grape juice, mango juice, juice from berries such as strawberry, raspberry, cranberry, blackberry, blueberry, peach, cherry, banana, apricot, passion fruit, elderberry etc may be used. Alkaline, acidic or neutral fruit juices may be used provided that the pH of the product is within the range pH 5.3 to 8.0. The fruit or fruit juice may be added as a concentrate or extract from the fruit. The fruit or fruit juice is preferably present in an amount of from 0.5 to 50 wt. %, more preferably 1 to 30 wt. %, most preferably 2 to 10 wt. %.

In addition to fruit or fruit juice, if an acidic product is desired, compositions may suitably contain one or more edible acids to bring the pH to the desired level. Examples of suitable edible acids are acetic acid, tartaric acid, citric acid and lactic acid. The fruit juice may be used to provide a part, or all, of the edible acid. Preferably the edible acid is provided in part by the straight addition of an acid and in part from the addition of one or more fruit juices.

The drink products may also optionally comprise one or more natural or artificial sweeteners. Suitable natural sweeteners include sucrose, fructose, glucose and maltose. The amount of the natural sweetener added is a matter of taste but will usually be in the range of from 1 to 25 wt. %, preferably of from 1 to 20 wt. %, most preferably 1 to 15 wt. %. Examples of suitable artificial sweeteners include sucralose and aspartame, for example used at from 0.01 to 1.0 wt. %. If any fruit juice is present in the formulation, this may add a part, or all, of the total amount of these sweeteners.

Drink products according to the invention can additionally comprise carbohydrate. Preferably the carbohydrate is maltodextrin, present in an amount from 0.1-5.0 wt. %, preferably from 0.25-4 wt. %, more preferably from 0.5-3 wt. %.

In a preferred embodiment of the invention, the aqueous drink product comprises one or more stabilisers which have a thickening effect on the drink product at the pH of the drink product. Any edible material which has a thickening effect at the pH of the drink product may be used, for example suitable pectins, gums, alginates and other hydrocolloids. Most preferred is the use of pectin or carrageenan as a stabiliser, examples of these are low-methoxy pectin, high-methoxy pectin, λ-carrageenan and τ-carrageenan.

The amount of thickener present in the composition is preferably from 0.01-2.0 wt. %, more preferably 0.02-1.0 wt. %, most preferably 0.02-0.25 wt. %.

The aqueous drink product comprises water in an amount preferably 65-94 wt. %, more preferably 80-92 wt. %.

The drink product according to the present invention can additionally comprise one or more various other ingredients incorporating any of the usual minor food or drink ingredients in conventional amounts, for example: added vitamins or minerals, carbohydrates, flavourings including herbs and spices, colourings, preservatives, flavour improvers, artificial sweeteners, aromas etc. Examples of such ingredients used herein are sequestering and non-sequestering minerals (such as sodium hexametaphosphate and sodium chloride respectively) and skimmed milk powder (SMP). Skimmed milk powder is an optional ingredient which can give the impression to the consumer of a more dairy-like taste.

The drink products can be prepared by any suitable method. In general the ingredients are mixed together under shear in the requisite amounts, then pasteurisation and/or sterilisation followed by homogenisation, finally the drink products are filled into their packaging. An example method follows the following five steps:—
1. Water, sucrose, soy-proteins, stabilisers and skimmed milk powder (if required) are mixed together under shear (approx. 1800 rpm) at 70° C.
2. The mixture of step 1 is mixed under low shear (approx. 600 rpm) at 70° C. for 15 minutes.
3. To the mixture of step 2, the saturated monoglyceride emulsifier is added, along with sunflower oil (if required), sodium chloride, sodium hexametaphosphate, tricalcium phosphate (and/or other inorganic salt(s)) and the balance of water is added.
4. Sterilisation step, 140-145° C./approx. 5 seconds
5. Homogenisation of the product, followed by filling into the packaging.

The pH of the drink products was between pH 5.3 and 8.0. Finally the drinks products are stored at a temperature of 5° C.

It is preferred that the water-insoluble edible inorganic salt is mixed with the protein prior to the preparation of the food product and that this mixture is used in the preparation of the drink product. It is especially preferred that soy protein is mixed with a calcium salt such as a calcium phosphate (for example tricalcium phosphate) or calcium carbonate.

The edible inorganic salt can be added separately to the composition, but also the salt can be incorporated into the soy protein, an example for calcium is Supro 760 (unhydrolysed isolated soy protein with 0.2% calcium from Solae). Optionally a combination of these factors can be used to introduce a water-insoluble edible inorganic salt such as calcium into the drink product, for example by using separate calcium addition, introduction via incorporation into the soy protein or a combination thereof.

The level of sedimentation can be appraised by two ways. The first is as a visual comparison, directly assessing the level of sedimentation between two drink products which have been stored for 1 week at 5° C. The second method again involves storing the drink product at 5° C. for 1 week, followed by removal and then weighing of the sediment. This test can give a percentage amount of sediment by weight of the product.

The invention is illustrated by the following non limiting examples.

### Examples

Aqueous drink products having the formulations B-F in table 1 were produced according to the method. In table 1, the term, ‘TCP’ stands for, ‘tricalcium phosphate’. All compositions made according to table 1 had a pH of approximately 7.

TABLE 1
Composition of the formulations (all values given in wt. %)

| Raw ingredients | | B | C | D | E | F |
|---|---|---|---|---|---|---|
| Proteins | Soy protein | 2.93 | 2.93 | 2.93 | 2.93 | 2.93 |
| Fats | Sunflower | 1.5 | 1.5 | 0.5 | | 1 |
| | Oil - High | | | | | |
| | Oleic | | | | | |
| | Saturated | | | 1 | 1.5 | 0.5 |
| | mono- | | | | | |
| | glyceride | | | | | |
| Carbohydrate | Maltodextrin | 1.3 | 1.3 | 1.3 | 1.3 | 1.3 |
| | Sucrose | 1.3 | 1.3 | 1.3 | 1.3 | 1.3 |
| Stabilisers | Λ-Carrageenan | | 0.02 | 0.05 | 0.02 | |
| | τ-Carrageenan | | 0.02 | 0.05 | 0.02 | |
| Inorganic | TCP | 0.232 | 0.232 | 0.232 | 0.232 | 0.232 |
| salts | | | | | | |
| Additional | Sodium | 0.05 | 0.05 | 0.05 | 0.05 | 0.05 |
| ingredients | hexameta | | | | | |
| | phosphate | | | | | |
| | Sodium | 0.08 | 0.08 | 0.08 | 0.08 | 0.08 |
| | chloride | | | | | |
| | Skimmed milk | 2.8 | 2.8 | 2.8 | 2.8 | 2.8 |
| | powder | | | | | |
| Water | (to balance) | 89.808 | 89.768 | 89.708 | 89.768 | 89.808 |
| Total | | 100 | 100 | 100 | 100 | 100 |

### Sedimentation Test Process

The drink products B-F were tested for sedimentation by storing the drink product at 5° C. for 1 week, followed by removal and then weighing of the sediment. This test gave a percentage amount of sediment by weight of the product. The drink products were tested against a benchmark semi-skimmed dairy milk, “melkunie” denoted herein as sample A and a benchmark soymilk, sample B, (produced according with the same method as the samples C-F, but not comprising a monoglyceride emulsifier).

### Sedimentation Test Results

The results of the sedimentation experiments are given in table 2. The various soymilk formulations (samples C-F), were tested again a benchmark soymilk, (sample B, produced to not comprise the saturated monoglyceride emulsifier and carrageenan stabilisers) and a benchmark semi-skimmed dairy milk (sample A).

TABLE 2
Sedimentation results of the various soymilk formulations

| Sample | Sedimentation (wt. %) | Comments |
|---|---|---|
| A | 0.08 | No sedimentation |
| B | 0.9 | Some sedimentation |
| C | 0.85 | Some sedimentation |
| D | 0.35 | A little sedimentation |
| E | 0.08 | No sedimentation |
| F | 0.85 | Some sedimentation |

The dairy milk product, sample A, has no particular visual degree of sedimentation, with a weight % sedimentation value of 0.08 wt. %. A corresponding acceptable value for soymilk for consumers has been found to be just above this at 0.25%. As can be clearly seen from the above results in table 2, the benchmark soymilk has an unacceptable level of 0.9 wt. % sedimentation, corresponding to a visual level of some noticeable sedimentation. Comparable levels were also found for samples C and F. Sample D has an improved amount of sedimentation, but is still above the acceptable level for consumers. Only soymilk E has an consumer acceptable level of sedimentation.

1. An aqueous drink product comprising:
a) from 1.0-6.0 wt. % soy protein;
b) from 0-10 wt. % fat;
c) from 0.25-1.75 wt. % saturated monoglyceride emulsifier;
d) from 0.01-2.5 wt. % of water-insoluble edible inorganic salts.

2. An aqueous drink product according to claim 1, wherein the saturated monoglyceride emulsifier is a saturated C₁₆ or C₁₈ monoglyceride emulsifier or a mixture thereof.

3. An aqueous drink product according to claim 1, wherein the water-insoluble edible inorganic salt is present in an amount of from 0.02-2 wt. %, preferably from 0.05-0.25 wt. %, even more preferably from 0.1-0.2 wt. %.

4. An aqueous drink product according to claim 1, wherein the water-insoluble edible inorganic salt is calcium phosphate or calcium carbonate or a mixture thereof.

5. An aqueous drink product according to claim 4, wherein the level of calcium present in the drink product is from 100 mg/100 ml to 400 mg/100 ml, preferably 120 mg/100 ml to 300 mg/100 ml, more preferably 140 mg/100 ml to 280 mg/100 ml.

6. An aqueous drink product according to claim 1, further comprising fruit or fruit juice.

7. An aqueous drink product according to claim 1 having a pH in the range of from pH 5.3 to 8.0.

8. An aqueous drink product according to claim 1, further comprising a second emulsifier which is not a saturated monoglyceride, in the range of from 0.1-5 wt. %; selected from the group comprising lecithins, diglycerides, diacetyl tartaric acid esters of mono- and diglycerides, sucrose esters of fatty acids, sodium steoroyl lactylate (SSL), citric acid esters of mono- and diglycerides, or a combination thereof.

9. An aqueous drink product according to claim 1, further comprising a thickener, preferably selected from the group of pectin and carrageenan, in an amount of from 0.01-20. wt. %.

10. An aqueous drink product according to claim 1, wherein the food product comprises water in an amount of from 65-96 wt. % based on the weight of the food product.
